(19) United States
(12) Patent Application Publication
(10) Pub. No.: US 2016/0238979 A1
(43) Pub. Date: Aug. 18, 2016

(54) IMAGE FORMING APPARATUS

(71) Applicant: OKI DATA CORPORATION, Tokyo (JP)

(72) Inventor: Hirotaka OHSHIKA, Tokyo (JP)

(21) Appl. No.: 14/944,210

(22) Filed: Nov. 18, 2015

(30) Foreign Application Priority Data
Feb. 16, 2015 (JP) 2015-027453

(51) Int. Cl. G03G 15/00; G03G 15/01

(52) U.S. Cl. CPC G03G 15/553; G03G 15/01

(57) ABSTRACT

An image forming apparatus includes an image forming portion; a usage amount calculating portion; a usage rate calculating portion; and a printable sheet number calculating portion. The image forming portion is configured to form an image on a printing medium using a color agent. The usage calculating portion is configured to calculate a usage amount of the color agent in the image forming portion. The usage rate calculating portion is configured to calculate a usage rate of the color agent on the printing medium according to the usage amount, and a medium size and a printed sheet number of the printing medium on which the image forming portion forms the image. The printable sheet number calculating portion is configured to calculate a printable sheet number that the image forming portion is capable of printing using a remaining color agent according to the usage amount and the usage rate.

### BACKGROUND OF THE INVENTION AND RELATED ART STATEMENT

The present invention relates to an image forming apparatus for forming an image.

A conventional image forming apparatus may be configured to display a printable sheet number according to a remaining amount of toner in a toner cartridge. For example, Patent Reference has disclosed a conventional image forming apparatus that calculates a printable sheet number under an assumption that a printing operation is continued with a predetermined coverage rate.

Patent Reference: Japanese Patent Publication No. 2012-252180

In the conventional image forming apparatus disclosed in Patent Reference, it has been desired to calculate a printable sheet number with higher accuracy, and it is necessary to improve calculation accuracy.

In order to solve the problems of the conventional image forming apparatus described above, an object of the present invention is to provide an image forming apparatus capable of calculating a printable sheet number with higher accuracy.

Further objects and advantages of the invention will be apparent from the following description of the invention.

### SUMMARY OF THE INVENTION

In order to attain the objects described above, according to a first aspect of the present invention, an image forming apparatus includes an image forming portion; a usage amount calculating portion; a usage rate calculating portion; and a printable sheet number calculating portion.

According to the first aspect of the present invention, the image forming portion is configured to form an image on a printing medium using a color agent. The usage calculating portion is configured to calculate a usage amount of the color agent in the image forming portion. The usage rate calculating portion is configured to calculate a usage rate of the color agent on the printing medium according to the usage amount, and a medium size and a printed sheet number of the printing medium on which the image forming portion forms the image. The printable sheet number calculating portion is configured to calculate a printable sheet number that the image forming portion is capable of printing using a remaining color agent according to the usage amount and the usage rate.

According to a second aspect of the present invention, an image forming apparatus includes an image forming portion and a calculating portion.

According to the second aspect of the present invention, the image forming portion is configured to use a color agent to form an image on a printing medium. The calculating portion is configured to calculate a usage amount of the color agent in the image forming portion. The calculating portion is further configured to calculate a usage rate of the color agent on the printing medium according to the usage amount, and a medium size and a printed sheet number of the printing medium on which the image forming portion forms the image. The calculating portion is further configured to calculate a printable sheet number that the image forming portion is capable of printing using a remaining color agent according to the usage amount and the usage rate.

According to the first aspect and the second aspect of the present invention, the image forming apparatus is configured to calculate the printable sheet number according to the usage amount of the color agent and the usage rate of the color agent on the printing medium. Accordingly, it is possible to calculate the printable sheet number with higher accuracy.

### BRIEF DESCRIPTION OF THE DRAWINGS

FIG. 1 is a schematic sectional view showing a configuration of an image forming apparatus according to a first embodiment of the present invention;

FIG. 2 is a schematic sectional view showing a configuration of a developing unit of the image forming apparatus according to the first embodiment of the present invention;

FIG. 3 is a block diagram showing a control system of the image forming apparatus according to the first embodiment of the present invention;

FIG. 4 is a view showing a table including correlation coefficients of the image forming apparatus according to the first embodiment of the present invention;

FIG. 5 is a schematic view sowing a display portion and an operation portion of the image forming apparatus according to the first embodiment of the present invention;

FIG. 6 is a flow chart showing an operation of the image forming apparatus according to the first embodiment of the present invention;

FIG. 7 is a view showing a table including printing conditions of the image forming apparatus according to the first embodiment of the present invention;

FIG. 8 is a view showing a table including calculation results under the printing conditions of the image forming apparatus according to the first embodiment of the present invention;

FIG. 9 is a block diagram showing a control system of an image forming apparatus according to a second embodiment of the present invention; and

FIG. 10 is a flow chart showing an operation of the image forming apparatus according to the second embodiment of the present invention.

### DETAILED DESCRIPTION OF PREFERRED EMBODIMENTS

Hereunder, embodiments of the present invention will be explained with reference to the accompanying drawings.

### First Embodiment

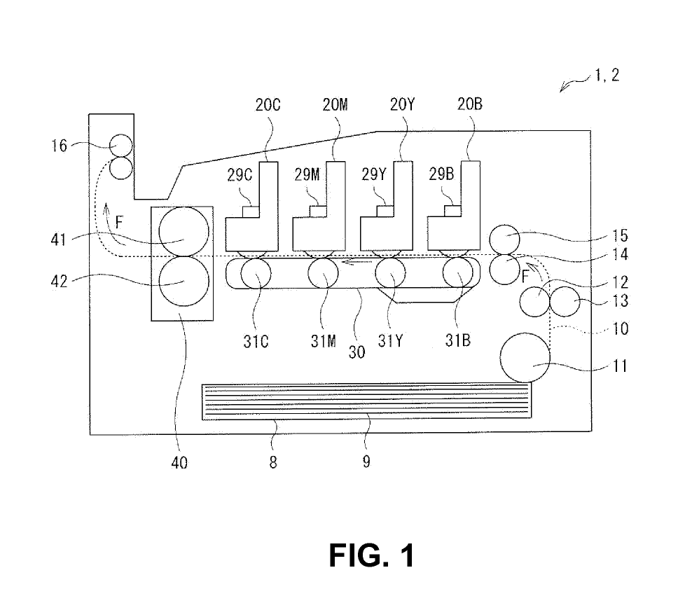

A first embodiment of the present invention will be explained. FIG. 1 is a schematic sectional view showing a configuration of an image forming apparatus 1 according to the first embodiment of the present invention. It should be noted that the image forming apparatus 1 is a tandem type printer capable of forming an image using a photo-electric method.

As shown in FIG. 1, the image forming apparatus 1 includes a hopping roller 11; a register roller 12; a pinch roller 13; a transportation roller 14; a pinch roller 15; developing units 20 (20B, 20Y, 20M, and 20C); light sources 29 (29B, 29Y, 29M, and 29C); a transfer portion 30; a fixing portion 40; and a discharge roller 16. These components are arranged along a transportation path 10 for transporting a printing medium 9.

In the first embodiment, the hopping roller 11 is configured to pick up the printing medium 9 at the upper most position retaining in a sheet supply tray 9. Further, the hopping roller 11 is configured to feed the printing medium 9 to the transportation path 10.

In the first embodiment, the register roller 12 is arranged to face the register roller 12 with the transportation path 10 in between. The pinch roller 13 is arranged to face the register roller 12 with the transportation path 10 in between. The register roller 12 and the pinch roller 13 are configured to correct skew of the printing medium 9 supplied from the hopping roller 11.

In the first embodiment, the transportation roller 14 is arranged to face the pinch roller 15 with the transportation path 10 in between. The pinch roller 15 is arranged to face the transportation roller 14 with the transportation path 10 in between. The transportation roller 14 and the pinch roller 15 are configured to transport the printing medium 9 supplied from the register roller 12 and the pinch roller 13 along the transportation path 10, so that the printing medium 9 is guided to the developing units 20 (20B, 20Y, 20M, and 20C).

In the first embodiment, the developing units 20 (20B, 20Y, 20M, and 20C) are configured to form a toner image. More specifically, the developing unit 20B is configured to form a toner image in black (B). The developing unit 20Y is configured to form a toner image in yellow (Y). The developing unit 20M is configured to form a toner image in magenta (M). The developing unit 20C is configured to form a toner image in cyan (C). The developing units 20 (20B, 20Y, 20M, and 20C) are arranged in this order along a transportation direction F of the printing medium 9. Further, each of the developing units 20 (20B, 20Y, 20M, and 20C) is configured to be detachable.

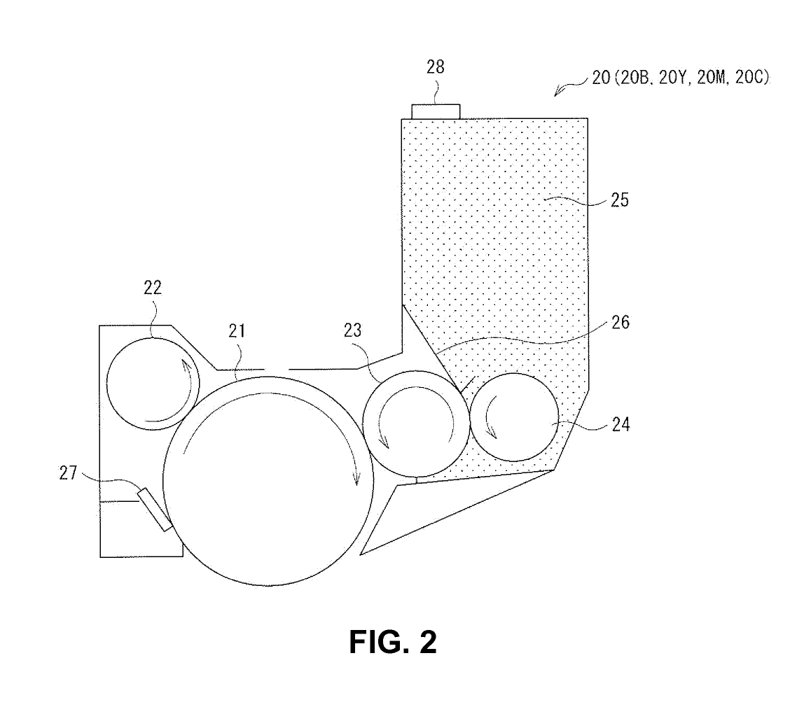

FIG. 2 is a schematic sectional view showing a configuration of the developing units 20 of the image forming apparatus 1 according to the first embodiment of the present invention.

As shown in FIG. 2, each of the developing units 20 includes a photosensitive drum 21; a charging roller 22; a developing roller 23; a supplying roller 24; a toner cartridge 25; a developing blade 26; a cleaning portion 27; and a data storage portion 28.

In the first embodiment, the photosensitive drum 21 is a component configured to support a static latent image on a surface (a surface layer portion) thereof. Further, the photosensitive drum 21 is formed of a photosensitive member. The photosensitive drum 21 is arranged to rotate in a right direction with a driving force transmitted from a photosensitive drum motor (not shown). The charging roller 22 is provided for charging the photosensitive drum 21.

In the first embodiment, the light source 29B is configured to expose the photosensitive drum 21 of the developing unit 20B. The light source 29Y is configured to expose the photosensitive drum 21 of the developing unit 20Y. The light source 29M is configured to expose the photosensitive drum 21 of the developing unit 20M. The light source 29C is configured to expose the photosensitive drum 21 of the developing unit 20C. Accordingly, the static latent image is formed on the surface of each of the photosensitive drums 21.

In the first embodiment, the charging roller 22 is a component configured to charge the surface (the surface layer portion) of the photosensitive drum 21. The charging roller 22 is arranged to contact with the surface (a circumferential surface) of the photosensitive drum 21, and is pressed against the photosensitive drum 21 with a specific press amount. When the photosensitive drum 21 is rotated, the charging roller 22 is rotated in a left direction. As described later, a power source 63 is provided for applying a charging voltage to the charging roller 22.

In the first embodiment, the developing roller 23 is a component configured to support toner on a surface thereof. Further, the developing roller 23 is formed of, for example, a metal shaft with a cylindrical shape and a semi-conductive elastic layer formed on a surface of the metal shaft. The elastic layer may be formed of, for example, a urethane rubber. It is desirable to apply an isocyanate processing to a surface of the elastic layer to enhance conductivity.

In the first embodiment, the developing roller 23 is arranged to contact with the surface (the circumferential surface) of the photosensitive drum 21, and is pressed against the photosensitive drum 21 with a specific press amount. The developing roller 23 is configured to rotate in the left direction with the photosensitive drum motor and a gear (not shown). It should be noted that a gear ratio is set such that a friction is generated between the surface of the developing roller 23 and the surface of the photosensitive drum 21 in each of the developing units 20. The developing roller 23 is provided for supplying toner to the photosensitive drum 21, so that the toner image is formed (developed) according to the static latent image. As described later, a power source 64 is provided for applying a developing voltage to the developing roller 23.

In the first embodiment, the supplying roller 24 is a component configured to supply toner retained in the toner cartridge 25 to the developing roller 23. Further, the supplying roller 24 is formed of, for example, a metal shaft with a cylindrical shape and a semi-conductive foamed elastic layer formed on a surface of the metal shaft. The foamed elastic layer may be formed of, for example, a silicone rubber with high wear resistance. Further, the supplying roller 24 is arranged to contact with the surface (a circumferential surface) of the developing roller 23, and is pressed against the developing roller 23 with a specific press amount. The supplying roller 24 is configured to rotate in the left direction with the photosensitive drum motor and a gear (not shown).

In the first embodiment, when the supplying roller 24 is rotated, a friction is generated between the surface of the supplying roller 24 and the surface of the developing roller 23 in each of the developing units 20. Accordingly, in each of the developing units 20, toner is charged through so-called friction charging. As described later, a power source 65 is provided for applying a supplying voltage to the supplying roller 24.

In the first embodiment, the toner cartridge 25 is a configured to retain toner. More specifically, the toner cartridge 25 of the developing unit 20B is configured to retain toner in black (B). The toner cartridge 25 of the developing unit 20Y is configured to retain toner in yellow (Y). The toner cartridge 25 of the developing unit 20M is configured to retain toner in magenta (M). The toner cartridge 25 of the developing unit 20C is configured to retain toner in cyan (C).

In the first embodiment, the developing blade 26 is a component arranged to abut against the surface of the developing roller 23. Accordingly, the developing blade 26 forms a layer of toner (a toner layer) on the surface of the developing roller 23, and regulates (controls or adjusts) a thickness of the toner layer. The developing blade 26 is formed of, for example, a plate shape elastic member formed of stainless and the like and formed in an L character shape. The developing blade 26 is arranged such that a curved portion thereof abuts against the surface of the developing roller 23, and the developing blade 26 is pressed against the developing roller 23 with a specific pressing amount. Similar to the supplying roller 24, the power source 65 is provided for applying the supplying voltage to the developing blade 26.

In the first embodiment, the cleaning portion 27 is a component configured to scrape off toner remaining on the surface (the surface layer) of the photosensitive drum 21 for cleaning. The cleaning portion 27 is arranged to abut against the surface of the photosensitive drum 21 with a counter force (protruding in a direction opposite to the rotational direction of the photosensitive drum 21), and is pressed against the photosensitive drum 21 with a specific press amount.

In the first embodiment, the data storage portion 28 is configured to store various data including a filled dot counter value Dt. The filled dot counter value Dt is defined as a value that a toner amount filled in the toner cartridge 25 (an initial amount immediately after filling up) is converted to a value per dot as an exposure unit of the developing unit 20. The data storage portion 28 may be formed of, for example, a so-called RFID (Radio Frequency Identifier). It is configured such that data stored in the data storage portion 28 is retrieved through a reading portion 66 (described later) using wired communication or wireless communication.

In the first embodiment, the light source 29B (refer to FIG. 1) is a component configured to irradiate light relative to the photosensitive drum 21 of the developing unit 20B. The light source 29Y is a component configured to irradiate light relative to the photosensitive drum 21 of the developing unit 20Y. The light source 29M is a component configured to irradiate light relative to the photosensitive drum 21 of the developing unit 20M. The light source 29C is a component configured to irradiate light relative to the photosensitive drum 21 of the developing unit 20C. Each of the light sources 29 may be formed of, for example, a plurality of LEDs (Light Emitting Diodes) arranged in a main scanning direction (a direction toward a backside in FIG. 1). It should be noted that the configuration of the light sources 29 is not limited thereto, and the light sources 29 may be formed of, for example, a laser light source. Each of the light sources 29 (29B, 29Y, 29M, and 29C) exposes the photosensitive drum 21 per dot. Accordingly, the static latent image is formed on the surface of the photosensitive drum 21.

In the first embodiment, the transfer portion 30 is a component configured to transfer the toner images formed with the developing units 20 (20B, 20Y, 20M, and 20C) to a transferred surface of the printing medium 9. The transfer portion 30 includes transfer rollers 31B, 31Y, 31M, and 31C. The transfer roller 31B is arranged to face the photosensitive drum 21 of the developing unit 20B with the transportation path 10 in between. The transfer roller 31Y is arranged to face the photosensitive drum 21 of the developing unit 20Y with the transportation path 10 in between. The transfer roller 31M is arranged to face the photosensitive drum 21 of the developing unit 20M with the transportation path 10 in between. The transfer roller 31C is arranged to face the photosensitive drum 21 of the developing unit 20C with the transportation path 10 in between. A power source 62 (described later) is provided for supplying a transfer voltage to each of the transfer rollers 31B, 31Y, 31M, and 31C. Accordingly, in the image forming apparatus 1, the toner images formed with the developing units 20 (20B, 20Y, 20M, and 20C) are transferred to the transferred surface of the printing medium 9.

In the first embodiment, the fixing portion 40 is a component configured to apply heat and a pressure to the printing medium 9, so that the toner images transferred to the printing medium 9 are fixed to the printing medium 9. The fixing portion 40 includes a heat roller 41 and a pressing roller 42. The heat roller 41 is a component configured to include a heating heater such as a halogen lump and the like disposed therein, so that the heat roller 41 applies heat to toner on the printing medium 9. The pressing roller 42 is a component arranged to form a pressing portion between the heat roller 41, so that the pressing roller 42 applies a pressure to toner on the printing medium 9. Accordingly, in the fixing portion 40, toner on the printing medium 9 is heated, pressed, and melted. As a result, the toner images are fixed to the printing medium 9.

In the first embodiment, the discharge roller 16 is a component to discharge the printing medium 9 outside the image forming apparatus 1.

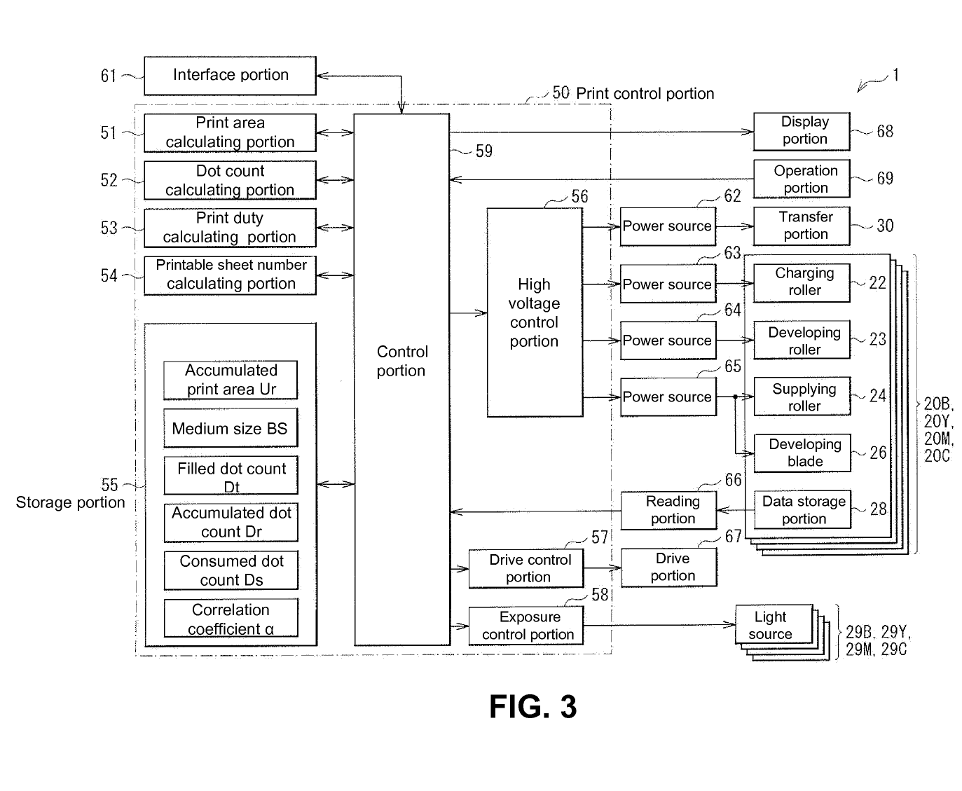

FIG. 3 is a block diagram showing a control system of the image forming apparatus 1 according to the first embodiment of the present invention.

As shown in FIG. 3, the image forming apparatus 1 includes an interface portion 61; a print control portion 50; the power source 62; the power source 63; the power source 64; the power source 65; the reading portion 66; a drive portion 67; a display portion 68; and an operation portion 69.

In the first embodiment, the interface portion 61 is configured to receive print data from a personal computer (not shown), and to communicate with the personal computer to receive and transmit various control signals.

In the first embodiment, the print control portion 50 is configured to control a printing operation of the image forming apparatus 1. The print control portion 50 includes a print area calculating portion 51; a dot count calculating portion 52; a print duty calculating portion 53; a printable sheet umber calculating portion 54; a storage portion 55; a high voltage control portion 56; a drive control portion 57; an exposure control portion 58; and a control portion 59. It should be noted that the print control portion 50 is not limited to the configuration described above. For example, the print control portion 50 may include a CPU (Central Processing Unit), an RAM (Random Access Memory), an ROM (Read Only Memory), and the like, so that the CPU performs an operation similar to those performed with the portions described above according to a program.

In the first embodiment, the print area calculating portion 51 is configured to calculate a print area S per print job according to the print data received with the interface portion 61. More specifically, first, the print area calculating portion 51 retrieves a medium size (for example, A4, B5, and the like) from the print data, and retrieves an area of a text region excluding a surrounding blank space. Then, the print area calculating portion 51 converts the area of the text region into a value (a region area S1) per unit dot as an exposure unit of the developing unit 20. At last, the print area calculating portion 51 calculates the print area S through multiplying the region area S1 with a sheet number N of the recording medium necessary to print the print data (S=S1×N).

In the first embodiment, the print area calculating portion 51 also has a function of updating an accumulated print area Ur through adding the print area S to the accumulated print area Ur stored in the storage portion 55.

In the first embodiment, the dot count calculating portion 52 is configured to calculate dot counts Dn (DnB, DnY, DnM, and DnC) per print job according to the print data received with the interface portion 61. More specifically, the dot count calculating portion 52 calculates a usage amount of toner in black (B), and converts the usage amount to a value per unit dot to calculate the dot count DnB. Similarly, the dot count calculating portion 52 calculates a usage amount of toner in black (Y), and converts the usage amount to a value per unit dot to calculate the dot count DnY; calculates a usage amount of toner in black (M), and converts the usage amount to a value per unit dot to calculate the dot count DnM; and calculates a usage amount of toner in black (C), and converts the usage amount to a value per unit dot to calculate the dot count DnC.

In the first embodiment, the dot count calculating portion 52 also has a function of updating accumulated dot counts Dr (DrB, DrY, DrM, and DrC) through adding the dot counts Dn (DnB, DnY, DnM, and DnC) to the accumulated dot counts Dr (described later) stored in the storage portion 55. More specifically, the dot count calculating portion 52 updates the accumulated dot count DrB through adding the dot count DnB to the accumulated dot count DrB; updates the accumulated dot count DrY through adding the dot count DnY to the accumulated dot count DrY; updates the accumulated dot count DrM through adding the dot count DnM to the accumulated dot count DrM; and updates the accumulated dot count DrC through adding the dot count DnC to the accumulated dot count DrC.

In the first embodiment, the dot count calculating portion 52 also has a function of calculating toner remaining amount dot counts Dz (DzB, DzY, DzM, and DzC) through subtracting the accumulated dot counts Dr (DrB, DrY, DrM, and DrC) stored in the storage portion 55 from filled dot counts Dt (DtB, DtY, DtM, and DtC; described later) stored in the storage portion 55. More specifically, the dot count calculating portion 52 calculates the toner remaining amount dot count DzB through subtracting the accumulated dot count DrB from the filled dot count DtB; calculates the toner remaining amount dot count DzY through subtracting the accumulated dot count DrY from the filled dot count DtY; calculates the toner remaining amount dot count DzM through subtracting the accumulated dot count DrM from the filled dot count DtM; and calculates the toner remaining amount dot count DzC through subtracting the accumulated dot count DrC from the filled dot count DtC.

In the first embodiment, the dot count calculating portion 52 also has a function of calculating toner remaining amounts T (TB, TY, TM, and TC; described later) in the toner cartridge 25 according to the toner remaining amount dot counts Dz (DzB, DzY, DzM, and DzC), and the filled dot counts Dt (DtB, DtY, DtM, and DtC); described later) stored in the storage portion 55. More specifically, the dot count calculating portion 52 calculates the toner remaining amount TB through dividing the toner remaining amount dot count DzB by the filled dot count DtB; calculates the toner remaining amount TY through dividing the toner remaining amount dot count DzY by the filled dot count DtY; calculates the toner remaining amount TM through dividing the toner remaining amount dot count DzM by the filled dot count DtM; and calculates the toner remaining amount TC through dividing the toner remaining amount dot count DzC by the filled dot count DtC.

In the first embodiment, the dot count calculating portion 52 also has a function of updating consumed dot counts Ds (DsB, DsY, DsM, and DsC) through adding the dot counts Dn (DnB, DnY, DnM, and DnC) to the consumed dot counts Ds (described later) stored in the storage portion 55. More specifically, the dot count calculating portion 52 updates the consumed dot count DsB through adding the dot count DnB to the consumed dot count DsB; updates the consumed dot count DsY through adding the dot count DnY to the consumed dot count DsY; updates the consumed dot count DsM through adding the dot count DnM to the consumed dot count DsM; and updates the consumed dot count DsC through adding the dot count DnC to the consumed dot count DsC.

In the first embodiment, the print duty calculating portion 53 is configured to calculate average print duties A (AB, AY, AM, and AC) according to the consumed dot counts Ds (DsB, DsY, DsM, and DsC) stored in the storage portion 55, an accumulated print area Ur (described later), a medium size BS (described later), and a correction coefficient α using the following equations (1) to (4):

AB=DsB/Ur×α (1)

AY=DsY/Ur×α (2)

AM=DsM/Ur×α (3)

AC=DsC/Ur×α (4)

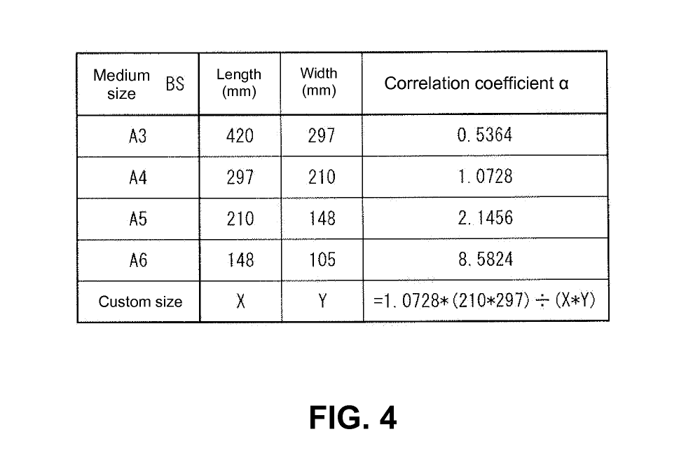

FIG. 4 is a view showing a table including the correlation coefficients α of the image forming apparatus 1 according to the first embodiment of the present invention. As shown in FIG. 4, the correlation coefficients α vary according to the medium size BS. Accordingly, the print duty calculating portion 53 calculates the average print duties A (AB, AY, AM, and AC) according to using the correlation coefficients α varying according to the medium size BS.

In the first embodiment, the printable sheet umber calculating portion 54 is configured to calculate printable sheet numbers M (MB, MY, MM, and MC) according to the toner remaining amount dot counts Dz (DzB, DzY, DzM, and DzC), the average print duties A (AB, AY, AM, and AC), the medium size BS, and the correction coefficient α using the following equations (5) to (8):

MB=DzB/(AB×B)×α (5)

MY=DsY/(AY×B)×α (6)

MM=DsM/(AM×B)×α (7)

MC=DsC/(AC×B)×α (8)

where B is a value (a text region area) obtained through converting the area of the text region excluding the surrounding blank space to a value per dot unit in the printing medium 9 with the medium size BS.

In the first embodiment, the storage portion 55 may be formed of, for example, a non-volatility memory. The storage portion 55 is configured to store the accumulated print area Ur, the medium size BS, the filled dot counts Dt (DtB, DtY, DtM, and DtC), the accumulated dot counts Dr (DrB, DrY, DrM, and DrC), and the consumed dot counts Ds (DsB, DsY, DsM, and DsC).

In the first embodiment, the accumulated print area Ur is obtained through accumulating the print area S per print job. It is configured such that the accumulated print area Ur is reset together with the consumed dot counts Ds (DsB, DsY, DsM, and DsC) at an arbitrary timing through an operation of a user.

In the first embodiment, the user operates the operation portion 69 to set the medium size BS in advance. More specifically, the user selects a standard size (for example, A4, B5, and the like), or operates a ten-key of the operation portion 69 to be able to set an arbitrary size (a custom size).

In the first embodiment, when the toner cartridge 25 is replaced, for example, the filled dot counts Dt (DtB, DtY, DtM, and DtC) are retrieved from the data storage portion 28 and are stored in the storage portion 55. More specifically, for example, when the toner cartridge 25 of the developing unit 20B, the filled dot count Dt retrieved from the data storage portion 28 of the developing unit 20B is stored in the storage portion 55 as the filled dot count DtB. Similarly, when the toner cartridge 25 of the developing unit 20Y, the filled dot count Dt retrieved from the data storage portion 28 of the developing unit 20Y is stored in the storage portion 55 as the filled dot count DtY. When the toner cartridge 25 of the developing unit 20M, the filled dot count Dt retrieved from the data storage portion 28 of the developing unit 20M is stored in the storage portion 55 as the filled dot count DtM. When the toner cartridge 25 of the developing unit 20C, the filled dot count Dt retrieved from the data storage portion 28 of the developing unit 20C is stored in the storage portion 55 as the filled dot count DtC.

In the first embodiment, the accumulated dot counts Dr (DrB, DrY, DrM, and DrC) are obtained through accumulating the dot counts Dn (DnB, DnY, DnM, and DnC) per print job. Further, it is configured such that the accumulated dot counts Dr (DrB, DrY, DrM, and DrC) are reset when the toner cartridge 25 is replaced. More specifically, when the toner cartridge 25 of the developing unit 20B is replaced, for example, the accumulated dot count DrB is reset. When the toner cartridge 25 of the developing unit 20Y is replaced, the accumulated dot count DrY is reset. When the toner cartridge 25 of the developing unit 20M is replaced, the accumulated dot count DrM is reset. When the toner cartridge 25 of the developing unit 20C is replaced, the accumulated dot count DrC is reset.

In the first embodiment, the consumed dot counts Ds (DsB, DsY, DsM, and DsC) are obtained through accumulating the dot counts Dn (DnB, DnY, DnM, and DnC) per print job. Further, it is configured such that the consumed dot counts Ds (DsB, DsY, DsM, and DsC) are reset together with the accumulated print area Ur at an arbitrary timing through an operation of the user.

In the first embodiment, when the print duty calculating portion 53 calculates the average print duties A (AB, AY, AM, and AC), the printable sheet umber calculating portion 54 uses the correction coefficient α to calculate the printable sheet numbers M (MB, MY, MM, and MC). As shown in FIG. 4, the correction coefficient α has difference values according to the medium size BS.

In the first embodiment, the high voltage control portion 56 is configured to control the power source 62, the power source 63, the power source 63, and the power source 65 to apply the voltage to each component in the transfer portion 30 and each of the developing units 20. More specifically, the high voltage control portion 56 controls the power source 62 to generate the transfer voltage to be applied to the transfer portion 30. Further, the high voltage control portion 56 controls the power source 63 to generate the charging voltage to be applied to the charging roller 22 of each of the developing units 20 (20B, 20Y, 20M, and 20C). Further, the high voltage control portion 56 controls the power source 64 to generate the developing voltage to be applied to the developing roller 23 of each of the developing units 20 (20B, 20Y, 20M, and 20C). Further, the high voltage control portion 56 controls the power source 65 to generate the voltage to be applied to the supplying roller 24 and the developing blade 26 of each of the developing units 20 (20B, 20Y, 20M, and 20C).

In the first embodiment, the drive control portion 57 is configured to control the drive portion 67, so that each motor in the image forming apparatus 1 is operated. Accordingly, the drive control portion 57 is capable of rotating the photosensitive drum 21 of each of the developing units 20, the hopping roller 11, the register roller 12, and the like. Further, the exposure control portion 58 is configured to control the exposure operation of the light sources 29 (29B, 29Y, 29M, and 29C).

In the first embodiment, the control portion 59 is configured to control each unit in the print control portion 50. Further, the print control portion 50 has a function of receiving the print data from the interface portion 61, and controlling an operation of the interface portion 61. Further, the control portion 59 retrieves the filled dot counts Dt (DtB, DtY, DtM, and DtC) from the data storage portion 28 of each of the developing units 20 through the reading portion 66. Further, the control portion 59 controls an operation of the image forming apparatus 1 according to operation information of the user supplied from the operation portion 69, and controls the display portion 68 to display various information.

In the first embodiment, the power source 62 is configured to generate the transfer voltage to be applied to the transfer portion 30 according to an instruction from the high voltage control portion 56. Further, the power source 63 is configured to generate the charging voltage to be applied to the charging roller 22 of each of the developing units 20 (20B, 20Y, 20M, and 20C) according to an instruction from the high voltage control portion 56. Further, the power source 64 is configured to generate the developing voltage to be applied to the developing roller 23 of each of the developing units 20 (20B, 20Y, 20M, and 20C) according to an instruction from the high voltage control portion 56. Further, the power source 65 is configured to generate the voltage to be applied to the supplying roller 24 and the developing blade 26 of each of the developing units 20 (20B, 20Y, 20M, and 20C) according to an instruction from the high voltage control portion 56.

In the first embodiment, the reading portion 66 is configured to retrieve the filled dot counts Dt (DtB, DtY, DtM, and DtC) from the data storage portion 28 of each of the developing units 20, and supplies the filled dot counts Dt (DtB, DtY, DtM, and DtC) to the control portion 59. Further, the drive portion 67 is configured to drive each motor in the image forming apparatus 1 according to an instruction from the drive control portion 57.

In the first embodiment, the display portion 68 is configured to display various types of information according to an instruction from the control portion 59. The display portion 68 is formed of, for example, a liquid crystal display panel.

In the first embodiment, the operation portion 69 is configured to receive an operation of the user. More specifically, the user can reset the accumulated print area Ur and the consumed dot counts Ds (DsB, DsY, DsM, and DsC) through operating the operation portion 69.

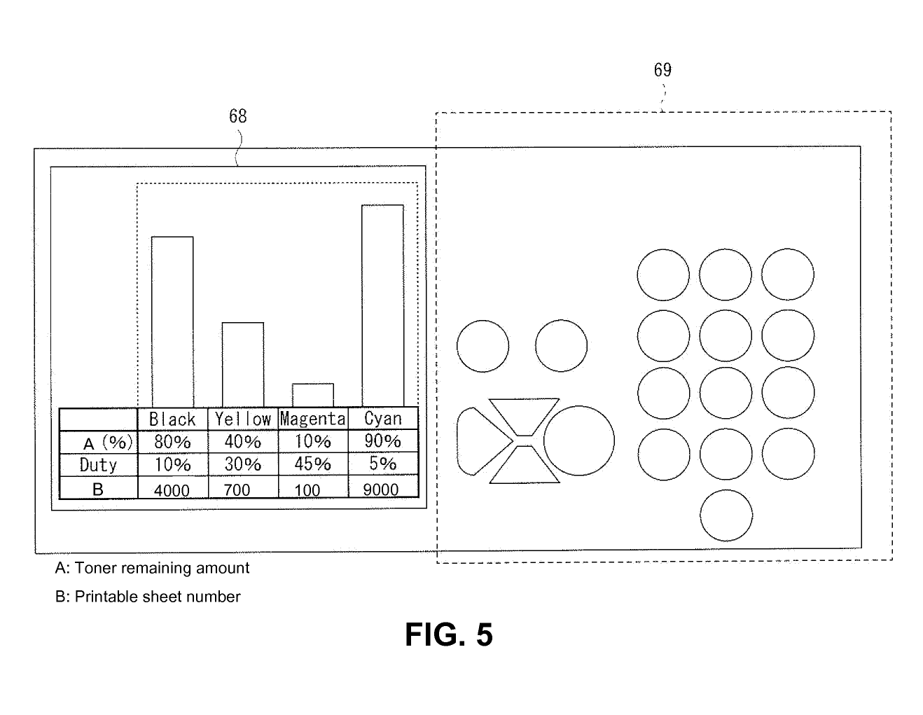

FIG. 5 is a schematic view sowing the display portion 68 and the operation portion 69 of the image forming apparatus 1 according to the first embodiment of the present invention.

As shown in FIG. 5, the operation portion 69 includes a plurality of buttons. The display portion 68 is configured to display a toner remaining amount T; an average print duty A; and a printable sheet number M per each color.

In the first embodiment, the developing units 20 (20B, 20Y, 20M, and 20C), the light sources 29 (29B, 29Y, 29M, and 29C), and the transfer portion 30 correspond to an image forming portion of the image forming apparatus 1. Toner is a specific example of a color agent. The dot count calculating portion 52 corresponds to a usage amount calculating portion of the image forming apparatus 1. The accumulated dot counts Dr (DrB, DrY, DrM, and DrC) and the consumed dot counts Ds (DsB, DsY, DsM, and DsC) correspond to a specific example of a usage amount. The print duty calculating portion 53 corresponds to a usage rate calculating portion of the image forming apparatus 1. The average print duties A (AB, AY, AM, and AC) correspond to a specific example of a usage rate. The accumulated print area Ur corresponds to a specific example of a print area. The interface portion 61 corresponds to a data obtaining portion of the image forming apparatus 1. The photosensitive drum 20 corresponds to an image supporting portion of the image forming apparatus 1. The developing roller 23 corresponds to a developing portion of the image forming apparatus 1.

An operation of the image forming apparatus 1 will be explained next. First, an overall operation of the image forming apparatus 1 will be explained with reference to FIG. 3.

In the first embodiment, the interface portion 61 is configured to receive the print data from a personal computer (not shown), and to communicate with the personal computer to receive and transmit various control signals. The print control portion 50 is configured to control the printing operation of the image forming apparatus 1.

More specifically, the print area calculating portion 51 is configured to calculate the print area S per print job according to the print data received with the interface portion 61. The dot count calculating portion 52 is configured to calculate the dot counts Dn (DnB, DnY, DnM, and DnC) per print job according to the print data received with the interface portion 61. The print duty calculating portion 53 is configured to calculate the average print duties A (AB, AY, AM, and AC) according to the consumed dot counts Ds (DsB, DsY, DsM, and DsC) stored in the storage portion 55, the accumulated print area Ur, the medium size BS (described later), and the correction coefficient α.

Further, the printable sheet umber calculating portion 54 is configured to calculate the printable sheet numbers M (MB, MY, MM, and MC) according to the toner remaining amount dot counts Dz (DzB, DzY, DzM, and DzC), the average print duties A (AB, AY, AM, and AC), the medium size BS, and the correction coefficient α. The high voltage control portion 56 is configured to control the power source 62, the power source 63, the power source 63, and the power source 65 to apply the voltage to each component in the transfer portion 30 and each of the developing units 20. The drive control portion 57 is configured to control the drive portion 67, so that each motor in the image forming apparatus 1 is operated. Further, the exposure control portion 58 is configured to control the exposure operation of the light sources 29 (29B, 29Y, 29M, and 29C).

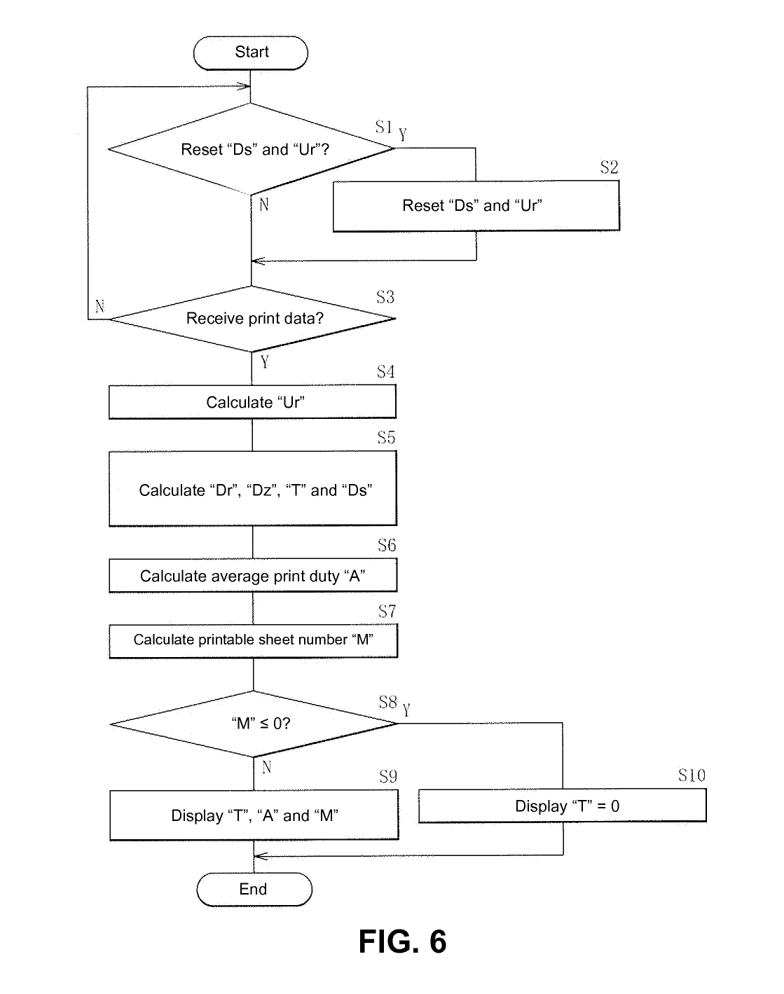

FIG. 6 is a flow chart showing the operation of the image forming apparatus 1 when the print control portion 50 calculates the printable sheet numbers M (MB, MY, MM, and MC) according to the first embodiment of the present invention. Every time when the interface portion 61 receives the print data, the print control portion 50 calculates the average print duties A (AB, AY, AM, and AC) and the printable sheet numbers M (MB, MY, MM, and MC). In the following, the operation of the print control portion 50 will be explained in detail.

In step S1, the control portion 59 of the print control portion 50 determines whether the user operates the operation portion 69 to reset the consumed dot counts Ds (DsB, DsY, DsM, and DsC) and the accumulated print area Ur. In step S2, when the control portion 59 determines the user resets the consumed dot counts Ds (DsB, DsY, DsM, and DsC) and the accumulated print area Ur, the control portion 59 resets the consumed dot counts Ds (DsB, DsY, DsM, and DsC) stored in the storage portion 55 and the accumulated print area Ur.

In step S3, the control portion 59 determines whether the interface portion 61 receives the print data. When the control portion 59 determines that the interface portion 61 does not receive the print data (N in step S3), the process returns to step S1. Accordingly, the process between step S1 and step S3 is repeated until the interface portion 61 receives the print data.

In step S4, when the control portion 59 determines that the interface portion 61 receives the print data (Y in step S3), the print area calculating portion 51 calculates the accumulated print area Ur. More specifically, the print area calculating portion 51 retrieves the medium size of the printing medium 9 from the print data, and retrieves the area of the test region excluding the surrounding blank space of the printing medium 9. Then, the print area calculating portion 51 converts the area of the text region into the value per dot (the region area S1). In the next step, the print area calculating portion 51 multiplies the region area S1 by the sheet number N of the print medium necessary for printing the print data, so that the print area S is calculated (S=S1×N). Lastly, the print area calculating portion 51 adds the print area S to the accumulated print area Ur stored in the storage portion 55, so that the accumulated print area Ur is updated.

In step S5, the dot count calculating portion 52 calculates the accumulated dot counts Dr (DrB, DrY, DrM, and DrC), the toner remaining amount dot counts Dz (DzB, DzY, DzM, and DzC), the toner remaining amounts T (TB, TY, TM, and TC), and the consumed dot counts Ds (DsB, DsY, DsM, and DsC).

More specifically, the dot count calculating portion 52 calculates the usage amount of toner in black (B), and converts the usage amount to the value per unit dot to calculate the dot count DnB. Similarly, the dot count calculating portion 52 calculates the usage amount of toner in black (Y), and converts the usage amount to the value per unit dot to calculate the dot count DnY; calculates the usage amount of toner in black (M), and converts the usage amount to the value per unit dot to calculate the dot count DnM; and calculates the usage amount of toner in black (C), and converts the usage amount to the value per unit dot to calculate the dot count DnC.

Further, the dot count calculating portion 52 updates the accumulated dot count DrB through adding the dot count DnB to the accumulated dot count DrB; updates the accumulated dot count DrY through adding the dot count DnY to the accumulated dot count DrY; updates the accumulated dot count DrM through adding the dot count DnM to the accumulated dot count DrM; and updates the accumulated dot count DrC through adding the dot count DnC to the accumulated dot count DrC.

Further, the dot count calculating portion 52 calculates the toner remaining amount dot count DzB through subtracting the accumulated dot count DrB from the filled dot count DtB; calculates the toner remaining amount dot count DzY through subtracting the accumulated dot count DrY from the filled dot count DtY; calculates the toner remaining amount dot count DzM through subtracting the accumulated dot count DrM from the filled dot count DtM; and calculates the toner remaining amount dot count DzC through subtracting the accumulated dot count DrC from the filled dot count DtC.

Further, the dot count calculating portion 52 calculates the toner remaining amount TB through dividing the toner remaining amount dot count DzB by the filled dot count DtB; calculates the toner remaining amount TY through dividing the toner remaining amount dot count DzY by the filled dot count DtY; calculates the toner remaining amount TM through dividing the toner remaining amount dot count DzM by the filled dot count DtM; and calculates the toner remaining amount TC through dividing the toner remaining amount dot count DzC by the filled dot count DtC.

Further, the dot count calculating portion 52 updates the consumed dot count DsB through adding the dot count DnB to the consumed dot count DsB; updates the consumed dot count DsY through adding the dot count DnY to the consumed dot count DsY; updates the consumed dot count DsM through adding the dot count DnM to the consumed dot count DsM; and updates the consumed dot count DsC through adding the dot count DnC to the consumed dot count DsC.

In step S6, the print duty calculating portion 53 calculates the average print duties A (AB, AY, AM, and AC). More specifically, the print duty calculating portion 53 calculates the average print duties A (AB, AY, AM, and AC) according to the correction coefficient α corresponding to the medium size BS using the equations (1) to (4).

In step S7, the printable sheet umber calculating portion 54 calculates the printable sheet numbers M (MB, MY, MM, and MC). More specifically, the printable sheet umber calculating portion 54 calculates the text region area B according to the medium size BS, and calculates the printable sheet numbers M (MB, MY, MM, and MC) according to the text region area B using the equations (5) to (8).

In step S8, the control portion 59 determines whether any one of the printable sheet numbers M (MB, MY, MM, and MC) is equal to or less than zero.

In step S9, when the control portion 59 determines that all of the printable sheet numbers M (MB, MY, MM, and MC) is greater than zero (N in step S8), the display portion 68 displays the toner remaining amounts T (TB, TY, TM, and TC), the average print duties A (AB, AY, AM, and AC), and the printable sheet numbers M (MB, MY, MM, and MC).

In step S10, when the control portion 59 determines that one of the printable sheet numbers M (MB, MY, MM, and MC) is equal to or less than zero, the control portion 59 controls the display portion 68 to display information indicating that the remaining toner amount is zero.

In the first embodiment, after step S10, the process is complete. Afterward, the print control portion 50 repeats the process described above.

An effect of the image forming apparatus 1 will be explained next as compared to an image forming apparatus 1R of a comparative example. In the following description, it is assumed that the image forming apparatus 1 and the image forming apparatus 1R are capable of forming an image on the printing medium 9 having the medium size in a range between A6 and A3, and the image forming apparatus 1 and the image forming apparatus 1R form an image using only black toner.

According to the comparative example, it should be noted that the image forming apparatus 1R is configured to determine the printable sheet numbers M (MB, MY, MM, and MC) at a predetermined print duty (5%) and a predetermined medium size (A4) according to the toner remaining amount dot counts Dz (DzB, DzY, DzM, and DzC).

In an evaluation, the image forming apparatus 1 and the image forming apparatus 1R perform the printing operation under the following nine printing conditions C1 to C9. In the printing operation, the dot count DnB is 792 dots when the image forming apparatus 1R performs the printing operation on one sheet of the printing medium 9 with the size A4 at the print duty of 5%. Further, the region area S1 of one sheet of the printing medium 9 with the size A4 is 16,993 dots. Further, the filled dot count DtB is 7,920,000.

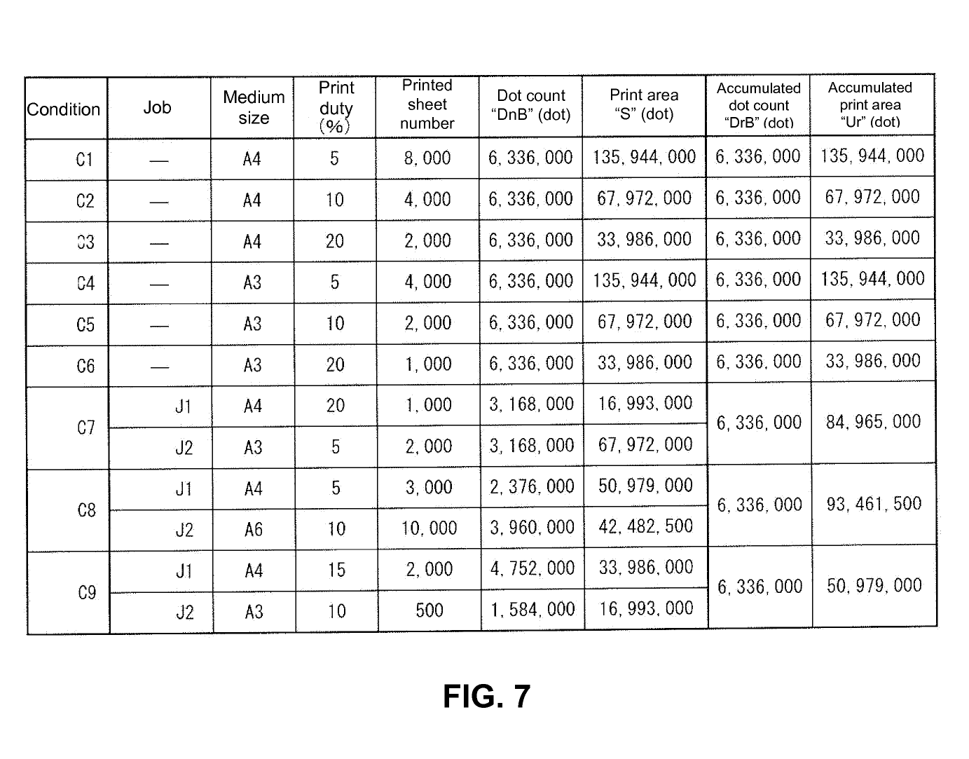

FIG. 7 is a view showing a table including the printing conditions C1 to C9 of the image forming apparatus 1R according to the comparative example and the image forming apparatus 1 according to the first embodiment of the present invention. It should be noted that one print job is performed under the printing conditions C1 to C6, and two print jobs are performed under the printing conditions C7 to C9.

Under the printing condition C1, for example, the image forming apparatus 1R performs the printing operation in black on 8,000 sheets of the printing medium 9 with the size A4 at the print duty of 5%. Under the printing condition C1, the dot count DnB is 6,336,000 (=792×8,000), and the print area S is 135,944,000 (=16,993×8,000). As a result, the accumulated dot count DrB is 6,336,000 dots, and the accumulated print area Ur is 135,944,000 dots.

Further, under the printing condition C4, for example, the image forming apparatus 1R performs the printing operation in black on 4,000 sheets of the printing medium 9 with the size A3 at the print duty of 5%. Under the printing condition C4, the dot count DnB is 6,336,000 (=792×2×4,000), and the print area S is 135,944,000 (=16,993×2×4,000). As a result, the accumulated dot count DrB is 6,336,000 dots, and the accumulated print area Ur is 135,944,000 dots.

Further, under the printing condition C7, for example, the image forming apparatus 1R performs the printing operation in black on 1,000 sheets of the printing medium 9 with the size A4 at the print duty of 20% for the print job J1, and on 2,000 sheets of the printing medium 9 with the size A3 at the print duty of 5% for the print job J2. For the print job J1, the dot count DnB is 3,168,000 (=792×(20/5)×1,000), and the print area S is 16,993,000 (=16,993×1,000). For the print job J2, the dot count DnB is 3,168,000 (=792×2×2,000), and the print area S is 67,972,000 (=16,993×2×2,000). As a result, after the image forming apparatus 1R performs the printing operation for the print job J1 and the print job J2, the accumulated dot count DrB is 6,336,000 dots, and the accumulated print area Ur is 84,965,000 dots.

In the printing operations described above, it should be noted that the accumulated dot count DrB becomes the same level of 6,336,000 dots under the printing conditions C1 to C9.

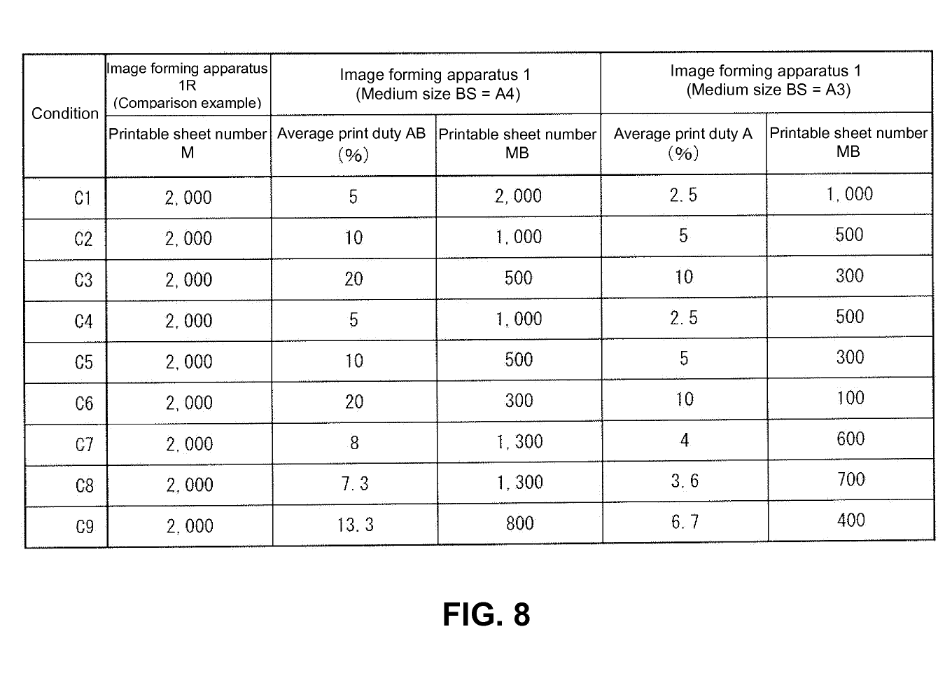

FIG. 8 is a view showing a table including calculation results of the printable sheet numbers M (MB, MY, MM, and MC) under the printing conditions C1 to C9 of the image forming apparatus 1R according to the comparative example and the image forming apparatus 1 according to the first embodiment of the present invention.

In the evaluation, the accumulated dot count DrB becomes the same level of 6,336,000 dots under the printing conditions C1 to C9. Accordingly, the toner remaining amount TB becomes the same level of 20% under the printing conditions C1 to C9.

According to the comparative example, the image forming apparatus 1R is configured to determine the printable sheet numbers M (MB, MY, MM, and MC) at the predetermined print duty (5%) and the predetermined medium size (A4) according to the toner remaining amount dot counts Dz (DzB, DzY, DzM, and DzC). As a result, the printable sheet number M is determined to be 2,000 sheets under the printing conditions C1 to C9.

As described above, in the image forming apparatus 1R according to the comparative example, the printable sheet numbers M (MB, MY, MM, and MC) are determines using the predetermined print duty (5%) and the predetermined medium size (A4). Accordingly, as shown in FIGS. 7 and 8, even when the medium size BS, the print duty, or the print number is varied, as long as the accumulated dot count is the same, the printable sheet number is determined at the same level. As a result, it is difficult to determine the printable sheet number with high accuracy.

In general, various users use an image forming apparatus under various conditions. For example, some of them print mostly texts, some of them print mostly images, some of them print many print media with the size A4, or some of them print many print media with the size B5. However, in the image forming apparatus 1R according to the comparative example, only the print duty and the medium size BS are variables. Accordingly, the calculation of the printable sheet number does not reflect actual print conditions, and it is difficult to determine the printable sheet number with high accuracy.

On the other hand, in the first embodiment, the image forming apparatus 1 first determines the average print duties A (AB, AY, AM, and AC), and then determines the printable sheet numbers M (MB, MY, MM, and MC) according to the average print duties A (AB, AY, AM, and AC). It should be noted that, when the toner cartridge 25 is replaced, the user operates the operation portion 69 to reset the consumed dot counts Ds (DsB, DsY, DsM, and DsC) and the accumulated print area Ur. In other words, the consumed dot counts Ds (DsB, DsY, DsM, and DsC) have the same values as those of the accumulated dot counts Dr (DrB, DrY, DrM, and DrC).

As shown in FIG. 8, in the image forming apparatus 1 in the first embodiment, even when the accumulated dot count DrB is the same, the average print duty AB is decreased as the accumulated print area Ur increases. Further, the image forming apparatus 1 determines the printable sheet number MB according to the average print duty AB. When the average print duty AB is increased, the printable sheet number MB is decreased. Accordingly, in the image forming apparatus 1, it is possible to determine the printable sheet number MB according to the printing conditions performed previously. Further, when the user sets the medium size BS in advance, it is possible to determine the printable sheet number MB according to the medium size BS that the user actually uses. Accordingly, the calculation of the printable sheet number reflects actual print conditions, and it is possible to determine the printable sheet number with high accuracy.

As described above, in the first embodiment, the printable sheet numbers M (MB, MY, MM, and MC) are determined according to the average print duties A (AB, AY, AM, and AC). Accordingly, it is possible to determine the printable sheet number with high accuracy.

In the first embodiment, the display portion 68 is configured to display the toner remaining amounts T (TB, TY, TM, and TC), the average print duties A (AB, AY, AM, and AC), the printable sheet numbers M (MB, MY, MM, and MC) for all four colors. It should be noted that the present invention is not limited to the configuration. Alternatively, the display portion 68 may be configured to display only the printable sheet numbers M (MB, MY, MM, and MC) for all four colors. Further, the display portion 68 may be configured to display only one of the printable sheet numbers M (MB, MY, MM, and MC) with the least number.

### Second Embodiment

A second embodiment of the present invention will be explained next. In the second embodiment, it is configured to obtain the medium size BS through a different process from that in the first embodiment. In the second embodiment, components of an image forming apparatus 2 similar to those of the image forming apparatus 1 in the first embodiment are designated with the same reference numerals, and explanations thereof are omitted.

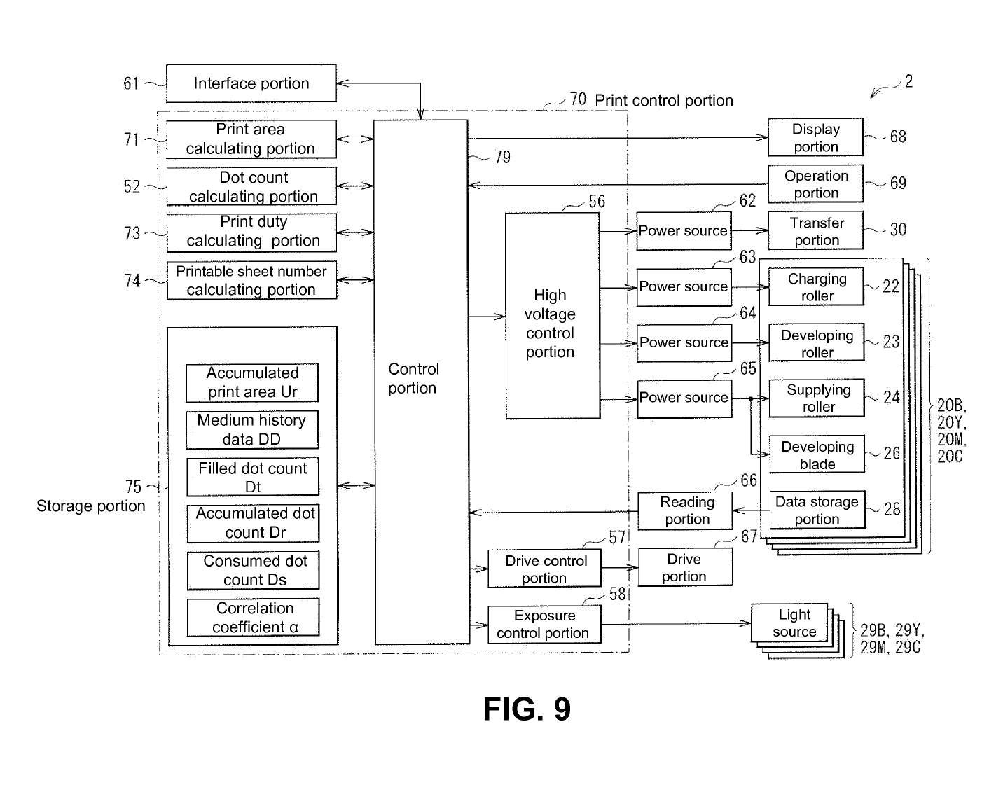

FIG. 9 is a block diagram showing a control system of the image forming apparatus 2 according to the second embodiment of the present invention.

As shown in FIG. 9, the image forming apparatus 2 includes a print control portion 70. The print control portion 70 includes a print area calculating portion 71; a print duty calculating portion 73; a printable sheet umber calculating portion 74; a storage portion 75; and a control portion 79.

In the second embodiment, similar to the print area calculating portion 51 in the first embodiment, the print area calculating portion 71 is configured to calculate the print area S per print job according to the print data received with the interface portion 61. Further, the print area calculating portion 71 is configured to update the accumulated print area Ur. Further, the print area calculating portion 71 has a function of updating medium history data DD (described later) stored in the storage portion 75 according to the medium size of the printing medium 9.

In the second embodiment, the print duty calculating portion 73 is configured to calculate the average print duties A (AB, AY, AM, and AC) according to the consumed dot counts Ds (DsB, DsY, DsM, and DsC) stored in the storage portion 75, the accumulated print area Ur (described later), the medium history data DD (described later), and the correction coefficient α using the equations (1) to (4). More specifically, first, the print duty calculating portion 73 determines the medium size BS according to the medium history data DD. In this process, the print duty calculating portion 73 estimates the medium size that the user will likely use in the future according to, for example, the medium history data DD, so that the print duty calculating portion 73 determines the medium size as the medium size BS. Then, the print duty calculating portion 73 calculates the average print duties A (AB, AY, AM, and AC) using the correction coefficient α according to the medium size BS thus determined.

In the second embodiment, the printable sheet umber calculating portion 74 is configured to calculate the printable sheet numbers M (MB, MY, MM, and MC) according to the toner remaining amount dot counts Dz (DzB, DzY, DzM, and DzC), the average print duties A (AB, AY, AM, and AC), the medium size BS determined with the print duty calculating portion 73, and the correction coefficient α using the equations (5) to (8).

In the second embodiment, the storage portion 75 is configured to store the accumulated print area Ur, the medium history data DD, the filled dot counts Dt (DtB, DtY, DtM, and DtC), the accumulated dot counts Dr (DrB, DrY, DrM, and DrC), the consumed dot counts Ds (DsB, DsY, DsM, and DsC), and the correction coefficient α.

In the second embodiment, the medium history data DD represents a history of the medium sizes of the printing medium 9 that the image forming apparatus 2 printed. The medium history data DD may, for example, a print number per medium size. It is configured such that the medium history data DD is reset at an arbitrary timing through an operation of the user.

In the second embodiment, similar to the control portion 59 in the first embodiment, the control portion 79 is configured to control each unit in the print control portion 70.

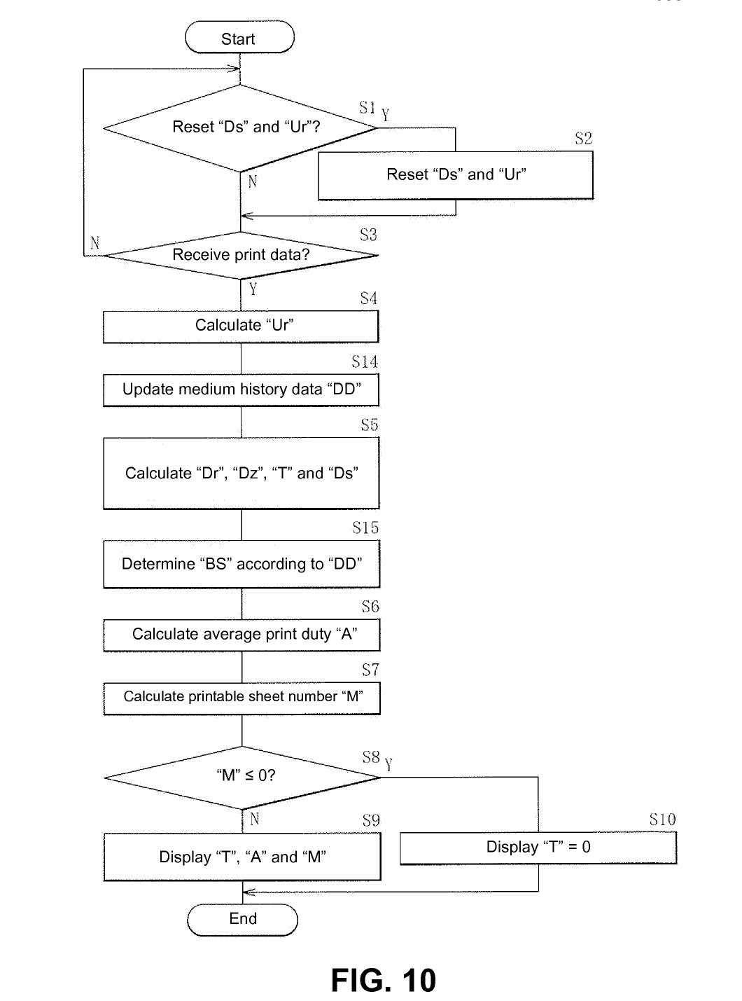

FIG. 10 is a flow chart showing an operation of the image forming apparatus 2 when the print control portion 70 calculates the printable sheet numbers M (MB, MY, MM, and MC) according to the second embodiment of the present invention.

In step S1, similar to the control portion 59 of the print control portion 50 in the first embodiment, the control portion 79 of the print control portion 70 determines whether the user operates the operation portion 69 to reset the consumed dot counts Ds (DsB, DsY, DsM, and DsC) and the accumulated print area Ur. In step S2, when the control portion 79 determines the user resets the consumed dot counts Ds (DsB, DsY, DsM, and DsC) and the accumulated print area Ur, the control portion 79 resets the consumed dot counts Ds (DsB, DsY, DsM, and DsC) stored in the storage portion 75 and the accumulated print area Ur.

In step S3, the control portion 79 determines whether the interface portion 61 receives the print data. When the control portion 79 determines that the interface portion 61 does not receive the print data (N in step S3), the process returns to step S1. Accordingly, the process between step S1 and step S3 is repeated until the interface portion 61 receives the print data.

In step S4, when the control portion 79 determines that the interface portion 61 receives the print data (Y in step S3), the print area calculating portion 71 calculates the accumulated print area Ur similarly to the print area calculating portion 51 in the first embodiment. Further, the print area calculating portion 71 adds the print area S to the accumulated print area Ur stored in the storage portion 75, so that the accumulated print area Ur is updated.

In step S14, the print area calculating portion 71 updates the medium history data DD stored in the storage portion 75 according to the medium size of the printing medium 9 obtained from the print data.

In step S5, the dot count calculating portion 52 calculates the accumulated dot counts Dr (DrB, DrY, DrM, and DrC), the toner remaining amount dot counts Dz (DzB, DzY, DzM, and DzC), the toner remaining amounts T (TB, TY, TM, and TC), and the consumed dot counts Ds (DsB, DsY, DsM, and DsC).

In step S15, the print duty calculating portion 73 determines the medium size BS according to the medium history data DD. More specifically, the print duty calculating portion 73 estimates the medium size that the user will likely use in the future according to, for example, the medium history data DD, so that the print duty calculating portion 73 determines the medium size as the medium size BS.

In step S6, the print duty calculating portion 73 calculates the average print duties A (AB, AY, AM, and AC) according to the correction coefficient α corresponding to the medium size BS.

In step S7, the printable sheet umber calculating portion 74 calculates the text region area B according to the medium size BS, and calculates the printable sheet numbers M (MB, MY, MM, and MC) according to the text region area B. The process after step S7 is the same as that in the first embodiment.

As described above, in the image forming apparatus 2 in the second embodiment, the medium size BS is determined according to the medium history data DD, and the average print duties A (AB, AY, AM, and AC) and the printable sheet numbers M (MB, MY, MM, and MC) are determined according to the medium size BS. Accordingly, it is possible to reflect the printing trend to the medium size, and to determine the printable sheet number with high accuracy.

As described above, in the second embodiment, the medium size BS is determined according to the medium history data DD. Accordingly, it is possible to determine the printable sheet number with high accuracy.

In the first embodiment and the second embodiment, the image forming apparatus 1 and the image forming apparatus 2 have the configurations described above. It should be noted that the present invention is not limited to the configurations, and may be applicable to modified configurations.

For example, in the first embodiment and the second embodiment, the present invention is applied to the printers of the photoelectric type. The present invention is not limited thereto, and may be applicable to various types of printers. For example, the present invention may be applicable to a printer of an inkjet type.

Further, in the first embodiment and the second embodiment, the present invention is applied to the color printers. The present invention is not limited thereto, and may be applicable to, for example, a monochrome printer.

Further, in the first embodiment and the second embodiment, the present invention is applied to the printers. The present invention is not limited thereto, and may be applicable to, for example, a multi function peripheral having functions of a printer, a facsimile, a scanner and the like.

The disclosure of Japanese Patent Application No. 2014-027453, filed on Nov. 20, 2014, is incorporated in the application.

While the invention has been explained with reference to the specific embodiments of the invention, the explanation is illustrative and the invention is limited only by the appended claims.

1. An image forming apparatus comprising:
an image forming portion configured to form an image on a printing medium using a color agent;
an operation portion configured to set a medium size;
a usage amount calculating portion configured to calculate a usage amount of the color agent in the image forming portion;
a usage rate calculating portion configured to calculate a usage rate of the color agent on the printing medium according to the usage amount, the medium size specified with the operation portion, and a printed sheet number of the printing medium on which the image forming portion forms the image; and
a printable sheet number calculating portion configured to calculate a printable sheet number that the image forming portion is capable of printing using a remaining color agent according to the usage amount and the usage rate.

2. The image forming apparatus according to claim 1, wherein said printable sheet number calculating portion is configured to calculate the printable sheet number according to history information related to the medium size of the printing medium on which the image forming portion forms the image.

3. The image forming apparatus according to claim 1, wherein said printable sheet number calculating portion is configured to calculate the printable sheet number according to the medium size of the printing medium specified with the operation portion in advance.

4. The image forming apparatus according to claim 1, wherein said usage rate calculating portion is configured to determine a print area according to the medium size and the printed sheet number of the printing medium on which the image forming portion forms the image, and
said usage rate calculating portion is configured to calculate the usage rate according to the usage amount and the print area.

5. The image forming apparatus according to claim 4, wherein said image forming portion is configured to form the image on the printing medium per unit dot,
said usage amount calculating portion is configured to calculate the usage amount per unit dot, and
said usage rate calculating portion is configured to calculate the print area per unit dot.

6. The image forming apparatus according to claim 4, further comprising an operation portion for receiving an operation of a user,
wherein said image forming portion includes a cartridge for retaining the color agent,
said usage amount calculating portion is configured to calculate the usage amount including a first usage amount and a second usage amount so that the first usage amount and the print area are reset when the operation portion receives the operation of the user, and the second usage amount is reset when the cartridge is replaced,
said usage rate calculating portion is configured to calculate the usage rate according to the first usage amount and the print area, and
said printable sheet number calculating portion is configured to calculate the printable sheet number according to the second usage amount and the usage rate.

7. The image forming apparatus according to claim 1, further comprising a data obtaining portion for obtaining print data,
wherein said usage amount calculating portion is configured to calculate the usage amount according to the print data.

8. The image forming apparatus according to claim 1, wherein said image forming portion includes a cartridge for retaining the color agent, and
said printable sheet number calculating portion is configured to calculate the printable sheet number according to an initial amount of the color agent retained in the cartridge.

9. The image forming apparatus according to claim 1, further comprising a display portion for displaying the printable sheet number.

10. The image forming apparatus according to claim 9, wherein said display portion is configured to display the usage rate.

11. The image forming apparatus according to claim 9, wherein said image forming portion is configured to form a plurality of images on the printing medium using a plurality of color agents,
said usage amount calculating portion is configured to calculate the usage amount of each of the color agents,
said usage rate calculating portion is configured to calculate the usage rate of each of the color agents according to the usage amount of each of the color agents, and
said printable sheet number calculating portion is configured to calculate the printable sheet number of each of the color agents according to the usage amount of each of the color agents and the usage rate of each of the color agents.

12. The image forming apparatus according to claim 11, wherein said display portion is configured to display the printable sheet number of each of the color agents.

13. The image forming apparatus according to claim 11, wherein said display portion is configured to display a minimum value among the printable sheet numbers.

14. The image forming apparatus according to claim 1, wherein said image forming portion is configured to form the image using developer as the color agent,
said image forming portion includes an image supporting portion for supporting a static latent image, and a developing portion for developing the static latent image through attaching the developer to the image supporting member.

15. An image forming apparatus comprising:
an image forming portion configured to form an image on a printing medium using a color agent;
an operation portion configured to set a medium size; and
a calculating portion configured to calculate a usage amount of the color agent in the image forming portion,
wherein said calculating portion is configured to calculate a usage rate of the color agent on the printing medium according to the usage amount, the medium size specified with the operation portion, and a printed sheet number of the printing medium on which the image forming portion forms the image, and
said calculating portion is configured to calculate a printable sheet number that the image forming portion is capable of printing using a remaining color agent according to the usage amount and the usage rate.

16. The image forming apparatus according to claim 1, wherein said usage rate calculating portion is configured to calculate the usage rate of the color agent according to a correction coefficient corresponding to the medium size specified with the operation portion.

17. The image forming apparatus according to claim 1, wherein said printable sheet number calculating portion is configured to calculate the printable sheet number according to a correction coefficient corresponding to the medium size specified with the operation portion.
